(19) United States
(12) Patent Application Publication
(10) Pub. No.: US 2026/0059347 A1
(43) Pub. Date: Feb. 26, 2026

(54) Uplink Coverage Enhancement Utilizing Radio Access Network Feature Consolidation

(71) Applicant: DISH Wireless L.L.C., Englewood, CO (US)

(72) Inventors: Joohyun LEE, Suwon-si (KR); Sang Boh YUN, Ashburn, VA (US); Gurpreet SOHI, Parker, CO (US); Sourabh GUPTA, Ashburn, VA (US)

(73) Assignee: DISH Wireless L.L.C., Englewood, CO (US)

(21) Appl. No.: 18/812,832

(22) Filed: Aug. 22, 2024

(51) Int. Cl. H04W 24/02; H04W 72/1268; H04W 72/51

(52) U.S. Cl. CPC H04W 24/02; H04W 72/1268; H04W 72/51

(57) ABSTRACT

A system to enhance coverage using features of a Radio Access Network (RAN) includes a feature consolidator configured to consolidate feature interconnections among the features of the RAN, receive uplink metrics and features capability from User Equipment (UE) to a Radio Unit (RU), determine a coverage deficiency, and identifying a feature combination based on the feature interconnections, the UE's features capability, and the coverage deficiency. A feature applicator is configured to apply the feature combination to a transmission of the uplink. Features of the RAN are related as not combinable, constrained, independent, synergistic, or synergistic with constraints, with the feature combination maximizing the synergy benefit to an uplink transmission.

### FIELD

The present teachings pertain to the enhancement of uplink (UL) coverage in mobile communication systems, particularly through the use of artificial intelligence and machine learning to analyze data and optimize feature combinations for improved performance.

### BACKGROUND

In typical macro cell environments in a Radio Access Network (RAN), an Uplink (UL) is a bottleneck in providing cell coverage. Generally, this may be because PUSCH reception performance is poor, especially near a cell edge and in indoor scenarios. Exemplary RANs affected by this problem include 3GPP RANs, such as Fourth Generation/Long Term Evolution (4G/LTE) and Fifth Generation/New Radio (5G/NR) RANs.

The 3GPP standard introduced various features to improve UL coverage. Moreover, various non-standard features and technologies have been studied. However, multiple features and technologies may not be combinable concurrently or some may be independent of each other. Some feature and technology combinations may provide synergy benefits, may provide side effects or may provide adverse effects. Furthermore, performance gains from synergistic combinations may be time varying. The time variance may be a result of inter/intra-cell interference, signal strength by UE location, service types (VoNR, data), latency requirements, or the like.

Previous approaches to optimizing feature combinations require complex configurations, leading to inefficiencies in managing feature interconnections and coordinating their operation. Efforts to improve coverage in RANs lack a comprehensive mechanism to consolidate feature interconnections, evaluate the capabilities of the UE, and dynamically identify feature combination based on coverage deficiencies identified from the uplink metrics. As a result, the ability to efficiently and effectively enhance coverage in RANs while considering the interplay of multiple features and network conditions remains a challenge in the field.

Moreover, while some solutions have attempted to address coverage deficiencies by applying specific features to the uplink, these approaches often lack flexibility in adapting to changing network conditions and may not fully leverage the capabilities of the UE to optimize coverage enhancement. The need persists for a system that can intelligently consolidate feature interconnections, analyze uplink metrics to identify coverage deficiencies, and dynamically identify and apply feature combination to enhance coverage in a RAN. However, none of these approaches have provided a comprehensive solution that combines the features described in this disclosure.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In some aspects, the techniques described herein relate to a system to enhance coverage using features of a Radio Access Network (RAN), the system including: a feature consolidator configured to consolidate feature interconnections among the features of the RAN, to receive, for an uplink from a User Equipment (UE) to a Radio Unit (RU), a features capability, a channel/service and uplink metrics, to determine a coverage deficiency in the uplink based on the uplink metrics, and to identify a feature combination based on the feature interconnections, the features capability, the channel/service and the coverage deficiency; and a feature applicator configured to apply the feature combination to a transmission of the uplink in real-time or near real time mode, wherein any two features of the features of the RAN are related as either not combinable, constrained, independent, synergistic, or synergistic with constraints, and wherein the identifying maximizes a synergy benefit of the feature combination.

In some aspects, the techniques described herein relate to a system, further including an operational policy including a cell operation policy and a feature combination policy, wherein the feature consolidator is configured to identify by inferring the feature combination based on the operational policy.

In some aspects, the techniques described herein relate to a system, wherein the channel/service is selected from a Physical Uplink Shared Channel (PUSCH)/Voice over New Radio (VoNR), PUSCH/large data (enhanced Mobile Broadband, eMBB), PUSCH/small data (massive Machine Type Communications, mMTC), PUSCH/reliable data (Ultra-Reliable Low-Latency Communications, URLLC), PUSCH/Msg3, Physical Uplink Control Channel (PUCCH), or Physical Random Access Channel (PRACH).

In some aspects, the techniques described herein relate to a system, wherein the features of the RAN include one or more of Repetition Type A, Repetition Type B, Intra/Inter-slot Frequency Hopping (FH), Intra/Inter-DU COMP Reception, TB over Multi-Slots (TBoMS), DMRS Bundling & Joint Channel Estimation (JCE), Dynamic PUCCH Repetition, Multi-TRP repetition, Dynamic Waveform Switching, Frequency Domain Spectrum Shaping (FDSS), or PRACH repetition.

In some aspects, the techniques described herein relate to a system, wherein the feature consolidator is further configured to train a Machine Learning (AI/ML) module on a RAN coverage data including a location and a signal strength.

In some aspects, the techniques described herein relate to a system, wherein the feature consolidator identifies the feature combination using an output of the (AI/ML) module.

In some aspects, the techniques described herein relate to a system, wherein the feature consolidator determines the feature combination using an output of the (AI/ML) module.

In some aspects, the techniques described herein relate to a system, wherein the feature consolidator is further configured to validate the feature combination with a feedback coverage check and to update the training of the AI/ML module.

In some aspects, the techniques described herein relate to a system, wherein the feature consolidator is further configured to analyze the RAN coverage data to detect historical uplinks with insufficient coverage and to predictively apply the feature combination.

In some aspects, the techniques described herein relate to a system, wherein the feature consolidator is further configured to analyze the RAN coverage data to detect that a gain from the feature combination is time-varying and to predictively determine the feature combination with the AI/ML module.

In some aspects, the techniques described herein relate to a method for enhancing coverage using features of a Radio Access Network (RAN), the method including: consolidating feature interconnections among the features of the RAN; receiving, for an uplink from a User Equipment (UE) to a Radio Unit (RU), a features capability, a channel/service and uplink metrics; determining a coverage deficiency in the uplink based on the uplink metrics; identifying a feature combination from the features of the RAN based on the feature interconnections, the features capability, the channel/service and the coverage deficiency; and applying the feature combination to a transmission of the uplink, wherein any two features of the features of the RAN are related as either not combinable, constrained, independent, synergistic, or synergistic with constraints, and wherein the identifying maximizes a synergy benefit of the feature combination.

In some aspects, the techniques described herein relate to a method, further including establishing an operational policy including a cell operation policy and a feature combination policy, wherein the identifying further includes inferring the feature combination based on the operational policy.

In some aspects, the techniques described herein relate to a method, wherein the channel/service is selected from a Physical Uplink Shared Channel (PUSCH)/Voice over New Radio (VoNR), PUSCH/large data (enhanced Mobile Broadband, eMBB), PUSCH/small data (massive Machine Type Communications, mMTC), PUSCH/reliable data (Ultra-Reliable Low-Latency Communications, URLLC), PUSCH/Msg3, Physical Uplink Control Channel (PUCCH), or Physical Random Access Channel (PRACH).

In some aspects, the techniques described herein relate to a method, wherein the features of the RAN include one or more of Repetition Type A, Repetition Type B, Intra/Inter-slot Frequency Hopping (FH), Intra/Inter-DU COMP Reception, TB over Multi-Slots (TBoMS), DMRS Bundling & Joint Channel Estimation (JCE), Dynamic PUCCH Repetition, Multi-TRP repetition, Dynamic Waveform Switching, Frequency Domain Spectrum Shaping (FDSS), or PRACH repetition.

In some aspects, the techniques described herein relate to a method, wherein the consolidating of the feature interconnections further includes training a Machine Learning (AI/ML) module on a RAN coverage data including a location and a signal strength.

In some aspects, the techniques described herein relate to a method, wherein the identifying includes identifying the feature combination using an output of the (AI/ML) module.

In some aspects, the techniques described herein relate to a method, wherein the consolidating further includes validating the feature combination with a feedback coverage check and updating the training of the AI/ML module.

In some aspects, the techniques described herein relate to a method, wherein the consolidating includes analyzing the RAN coverage data to detect historical uplinks with insufficient coverage and predictively applying the feature combination.

In some aspects, the techniques described herein relate to a method, wherein the consolidating includes analyzing the RAN coverage data to detect that a gain from the feature combination is time-varying and predictively determining the feature combination with the AI/ML module.

In some aspects, the techniques described herein relate to a non-transitory processor-readable storage medium having stored therein program code of one or more software programs for enhancing coverage using features of a Radio Access Network (RAN), wherein the program code when executed by at least one processing device causes the at least one processing device the perform: consolidating feature interconnections among the features of the RAN; receiving, for an uplink from a User Equipment (UE) to a Radio Unit (RU), a features capability, a channel/service and uplink metrics; determining a coverage deficiency in the uplink based on the uplink metrics; identifying a feature combination from the features of the RAN based on the feature interconnections, the features capability, the channel/service and the coverage deficiency; and applying the feature combination to a transmission of the uplink, wherein any two features of the features of the RAN are related as either not combinable, constrained, independent, synergistic, or synergistic with constraints, and wherein the identifying maximizes a synergy benefit of the feature combination.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates an embodiment of a hybrid cloud cellular network.

FIG. 2A illustrates candidate features for a channel/service according to various embodiments.

FIG. 2B illustrates consolidating features for a four-slot aggregation according to various embodiments.

FIG. 2C illustrates exemplary relationships between features according to various embodiments.

FIG. 3 illustrates a system to enhance UL coverage using combinations of features, according to various embodiments.

FIG. 4 is an exemplary functional framework for feature compositor according to various embodiments.

FIG. 5 illustrates a system to provide enhanced uplink coverage enhancement in a RAN, according to various embodiments.

FIG. 6 illustrates a method for enhancing coverage using features of a Radio Access Network coverage according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

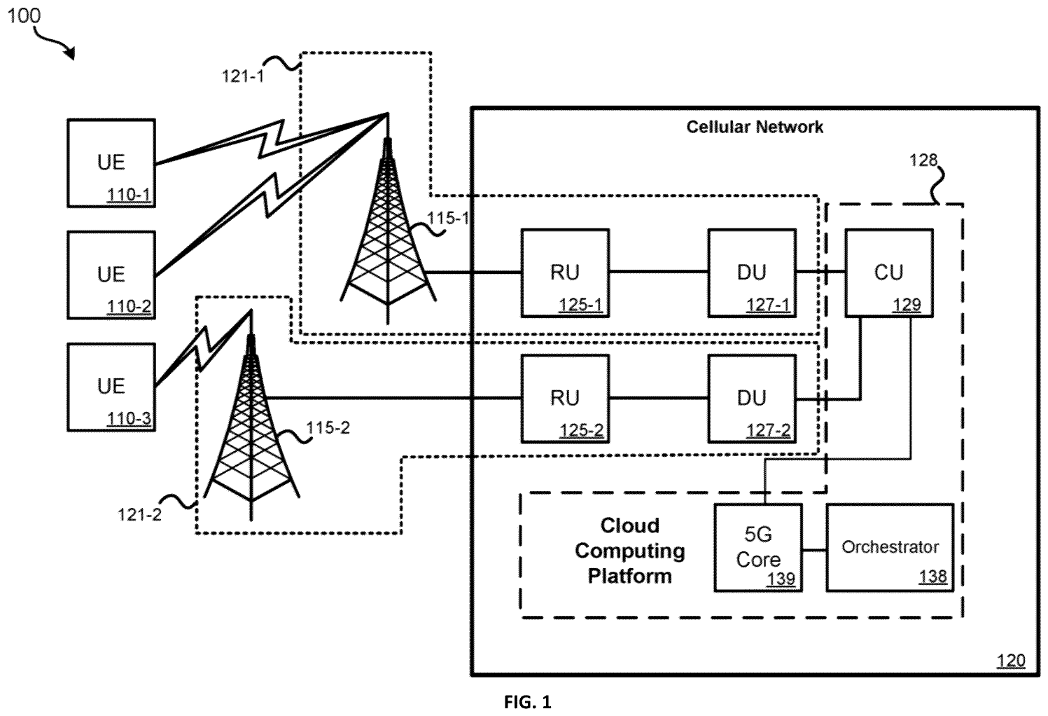

FIG. 1 illustrates a block diagram of a hybrid cellular network system (“system 100”). System 100 can include a 5G New Radio (NR) cellular network; other types of cellular networks, such as 6G, 7G, or the like, may also be possible. System 100 can include: UE 110 (UE 110-1, UE 110-2, UE 110-3); structure 115; cellular network 120; radio units 125 (“RUs 125”); distributed units 127 (“DUs 127”); centralized unit 129 (“CU 129”); 5G core 139; and orchestrator 138. FIG. 1 represents a component-level view. In an open radio access network (O-RAN), most components, except for components that need to receive and transmit RF, can be implemented as specialized software executed on general-purpose hardware or servers. For at least some components, a separate cloud-service computing platform provider may maintain the hardware. Therefore, the cellular network operator may operate some hardware (such as, RUs and local computing resources on which DUs are executed) connected with a cloud-computing platform on which other cellular network functions, such as the core and CUs are executed.

UE 110 can represent several types of end-user devices, such as cellular phones, smartphones, cellular modems, cellular-enabled computerized devices, sensor devices, robotic equipment, IoT devices, gaming devices, access points (APs), or any computerized device capable of communicating via a cellular network. More generally, UE 110 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, or the like. Depending on the location of individual UEs, UE 110 may use RF to communicate with various BSs of cellular network 120. BS 121 may include an RU (e.g., RU 125-1) and a DU (e.g., DU 127-1). Two BSs 121 (BS 121-1 and BS 121-2) are illustrated. BS 121-1 can include: structure 115-1, RU 125-1, and DU 127-1. Structure 115-1 may be any structure to which one or more antennas (not illustrated) of the BS are mounted. Structure 115-1 may be a dedicated cellular tower, a building, a water tower, or any other man-made or natural structure to which one or more antennas can be mounted to provide cellular coverage to a geographic area. Similarly, BS 121-2 can include: structure 115-2, RU 125-2, and DU 127-2.

Real-world implementations of system 100 can include many (e.g., thousands) of BSs and many CUs and 5G core 139. BS 121-1 can include one or more antennas that allow RUs 125 to communicate wirelessly with UEs 110. RUs 125 can represent an edge of cellular network 120 where data is transitioned to RF for wireless communication. The radio access technology (RAT) used by RU 125 may be 5G NR, or some other RAT. The remainder of cellular network 120 may be based on an exclusive 5G architecture, a hybrid 4G/5G architecture, or some other cellular network architecture that supports cellular network slices.

One or more RUs, such as RU 125-1, may communicate with DU 127-1. As an example, at a cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. In some embodiments, an RU can also operate on three bands. One or more DUs, such as DU 127-1, may communicate with CU 129. Collectively, an RU, DU, and CU create a gNB, which serves as the radio access network (RAN) of cellular network 120. DUs 127 and CU 129 can communicate with 5G core 139. The specific architecture of cellular network 120 can vary by embodiment. Edge cloud server systems (not illustrated) outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized implementation, CU 129, 5G core 139, and/or orchestrator 138 can be implemented as software being executed by general-purpose computing equipment on a cloud-computing platform 128, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where 5G core 139 is executed, while other functions are executed at a separate server system or on a separate cloud computing system. In the illustrated embodiment of system 100, cloud-computing platform 128 can execute CU 129, 5G core 139, and orchestrator 138. The cloud-computing platform 128 can be a third-party cloud-based computing platform or a cloud-based computing platform operated by the same entity that operates the RAN. Cloud-based computing platform 128 may have the ability to devote additional hardware resources to cloud-based cellular network components or implement additional instances of such components when requested.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU for test, orchestrator 138 can perform a pipeline of calling the DU code from a software repository incorporated as part of, or separate from cellular network 120, pulling corresponding configuration files (e.g. helm charts), creating Kubernetes nodes/pods, loading DU containers, configuring the DU, and activating other support functions (e.g. Prometheus, instances/connections to test tools). While this instantiation of a DU may be triggered by orchestrator 138, a chaos test system may introduce false DU container images in the repo, may introduce latency or memory issues in Kubernetes, may vary traffic messaging, and/or create other “chaos” in order to conduct the test. That is, chaos test system is not only connected to a DU but is connected to all the layers and systems above and below a DU, as an example.

Kubernetes, Docker®, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The traditional Operational Support Systems/Business Support Systems (OSS/BSS) stack exists above orchestrator 138. Chaos testing of these components, as well as other higher layer custom-built components. Such components can be required sources of information and agents for testing at the service/app/solution layer. One aim of chaos testing is to verify the business intent (service level objectives (SLOs) and SLAs) of the solution. Therefore, if we commit to an SLA with certain key performance indicators (KPIs), chaos testing can allow measuring whether those KPIs are being met and assessing resiliency of the system across all layers to meet them.

A cellular network slice functions as a virtual network operating on an underlying physical cellular network. Operating on cellular network 120 is some number of cellular network slices, such as hundreds or thousands of network slices. Communication bandwidth and computing resources of the underlying physical network can be reserved for individual network slices, thus allowing the individual network slices to reliably meet defined SLA requirements. By controlling the location and amount of computing and communication resources allocated to a network slice, the QoS and QoE for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular parameters that can be set for a cellular network slice can include uplink bandwidth per UE; downlink bandwidth per UE; aggregate uplink bandwidth for a client; aggregate downlink bandwidth for the client; maximum latency; access to particular services; and maximum permissible jitter.

Particular network slices may only be reserved in particular geographic regions. For instance, a first set of network slices may be present at RU 125-1 and DU 127-1, a second set of network slices, which may only partially overlap or may be different from the first set, may be reserved at RU 125-2 and DU 127-2.

Further, particular cellular network slices may include multiple defined slice layers. Each layer within a network slice may be used to define parameters and other network configurations for particular types of data. For instance, high-priority data sent by a UE may be mapped to a layer having higher QoS parameters and network configurations than lower-priority data sent by the UE that is mapped to a second layer having less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

The present teachings maximize the synergy benefit when combining the UL coverage enhancement features. Features and configurations for UL coverage enhancement are updated in real-time or near real time mode by monitoring a UL coverage gain. AI/ML inferences may be leveraged to train possible combinations of feature combinations. As an example, an O-RAN RIC platform acquires various measurement data from DUs. This data may be analyzed to detect UEs or UL channels with insufficient coverage. Based on the analysis results, appropriate features and configurations may be inferred/identified and checked for their combination benefits and side effects to enhance UL coverage for target UEs in near real time.

Cell coverage has a direct impact on service quality and number of cells for supporting the same coverage (due to CAPEX and OPEX). In the uplink, Physical Uplink Shared Channel (PUSCH) data service coverage can be a coverage bottleneck in the outdoor macro cell environment for services such as large data (enhanced Mobile Broadband, eMBB), small data (massive Machine Type Communications, mMTC), reliable data (Ultra-Reliable Low-Latency Communications, URLLC), and Msg3 for initial access by a UE. Furthermore, PUSCH voice service for Voice over New Radio (VoNR) also lacks coverage compared to other uplink channels such as Physical Uplink Control Channel (PUCCH) and Physical Random-Access Channel (PRACH). Moreover, per the MAPL (Max Allowable Path Loss) differences derived from 3GPP TR38.830, PUSCH data service coverage is a coverage bottleneck in a rural Outdoor to Indoor (O2I) scenario of the FR1 FDD 700 MHz band. If the repetition type A with max repetition of 4 was not applied for PUSCH VONR, PUSCH VONR service coverage would be a coverage bottleneck.

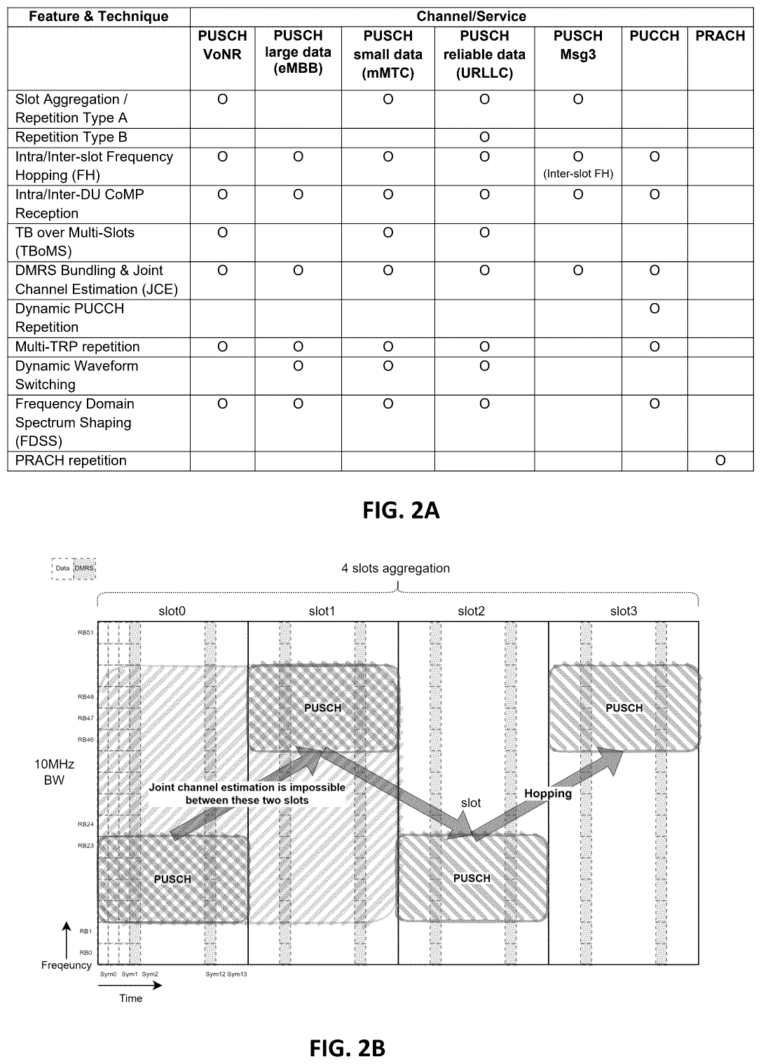

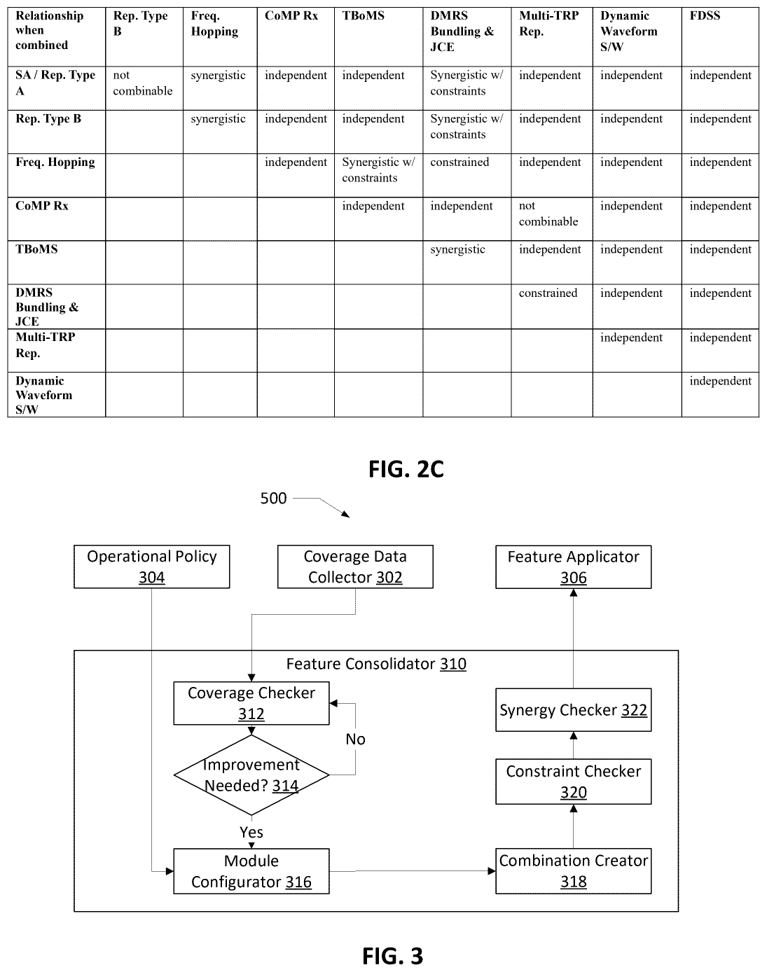

FIG. 2A illustrates candidate features for a channel/service according to various embodiments.

Features may be available over one or more channel/service combinations. For example, different services over the PUSCH may be amenable to some of the features supported by the RAN and the UE as illustrated in FIG. 2A. Moreover, all services over PUCCH and PRACH channels may be amenable to some of the features supported by the RAN and the UE. Relationships between channel/service and features may determine simultaneous enabling of UL features. Two or more features of the RAN jointly may be not combinable, constrained, independent, synergistic, synergistic with constraints. In one embodiment, relationships between features may be understood as the following:
Not combinable: Combined operation impossible with each other.
Constrained: Combined operation possible, but with some constraints.
Independent: Combined operation possible with independent benefits.
Synergistic: Combined operation possible with synergy benefits.
Synergistic w/constraints: Combined operation possible with synergistic benefits by considering constraints

In addition, network operators may consider how the coverage enhancement features impact other aspects of the system KPIs (Key Performance Indicators), such as latency, spectral efficiency, and additional overhead.

FIG. 2B illustrates consolidating features for a four-slot aggregation according to various embodiments.

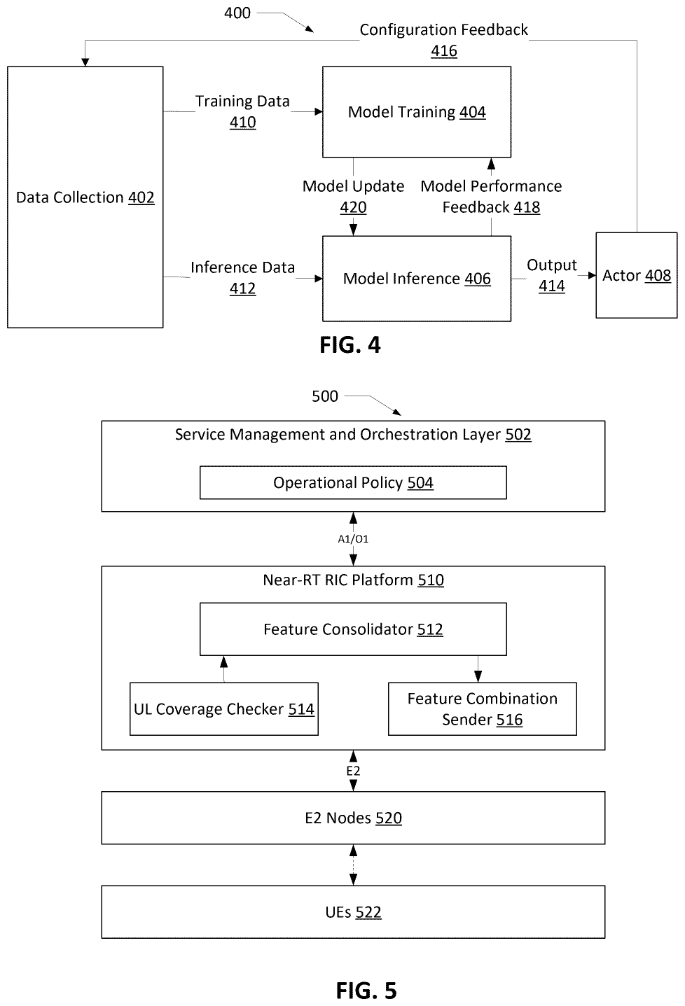

Enabling all UL features simultaneously may not always be beneficial in terms of UL coverage. For example, when inter-slot frequency hopping (FH) is applied, inter-slot joint channel estimation (JCE) cannot be applied because the channel changes for each slot. Furthermore, depending on its time and frequency selectivity, FH may be beneficial, JCE may be beneficial, or a combination of the two may be beneficial. Although constrained in the example of FIG. 4B, Intra-slot JCE may be combinable with inter-slot FH. However, inter-slot JCE is not combinable with any FH and intra-slot FH is not combinable with any JCE. Therefore, these features need to be carefully combined taking into account the constraints.

FIG. 2C illustrates exemplary relationships between features according to various embodiments.

FIG. 3 illustrates a system to enhance UL coverage using combinations of features, according to various embodiments.

A system 300 to enhance UL coverage using feature combinations may include a coverage data collector 302, an operational policy 304, a feature consolidator 310, and a feature applicator 306.

Coverage data collector 302 may be implemented at a DU that collects coverage data for each UE connected therefrom.

System 300 may include an Operational policy 304. Operational policy 304 may include a RAN architecture related service or PUSHCH policy based on whether a BS RU and DU supports Multi-TRP architecture, a Centralized-RAN, Distributed-RAN architecture, inter-DU data exchange or the like.

Operational policy 304 may include a service and feature related policy. This policy may provide a minimum data rate and latency requirements for VONR/eMBB/mMTC/URLLC services. Moreover, this policy may provide a link budget (maximum allowable path loss) for VoNR/eMBB/mMTC/URLLC services. This policy may provide whether the non-slot-based transmission is supported. This policy may provide whether BS and UE support each coverage enhancement feature. This policy may include an Operator's feature roadmap and an Operator's feature preference.

Operational policy 304 may include Target values and thresholds, for example, Power headroom threshold (PH_TH), a Target path loss of each service (Target_PL), a Max transmit power of each UE according to the UE power class (Pmax), a Target block error rate for each service (Target_BLER), or the like.

Feature consolidator 310 may use coverage data collector 302 and operational policy 304 as input to combine features of the RAN and provide a feature combination for the feature applicator 306 to apply to an uplink from a UE to RU. Feature consolidator 310 may include a coverage checker 312, a module configurator 316, a combination creator 318, a constraint checker 320 and a synergy checker 322.

According to various embodiments, a UL coverage check may be performed on collected DU data at coverage checker 312. The collected DU data may include scheduled UE and service information, UE measurements, and BS measurements. Exemplary UE measurements include RSRP, PH (Power Headroom report indicating how much Tx power is left to increase the transmitting power in the UE) and SINR. Exemplary BS measurements include P_PUSCH and related parameters (PL, SINR, or the like), Block Error Rate (BLER) (from CRC).

Coverage checker 312 may check UL coverage as follows. In some embodiments, when the UE's PH report is smaller than a threshold (TH), UL coverage of the currently scheduled service may be deemed insufficient. The PH may be calculated as:

PH=UE Max Tx Power−Current PUSCH Tx Power<TH_PH (close to zero)

A PL (Path Loss) may be estimated from the UE's RSRP report. The PL may be used to determine whether the link budget for the desired service is insufficient. The PL may be calculated as:

PL=referenceSignalPower−RSRP<Target_PL (from the link budget)

In some embodiments, a BS scheduler performs closed loop power control for each UE and a lack of coverage for each UE can be predicted as follows:

P_PUSCH=P max-PL+f(SINR)+α(PL−Δ_TF)+Δ_MCS+Δ_F+Δ_TPC>P max

In some embodiments, a short-term BLER statistic may indicate whether UL coverage is insufficient. The short-term BLER statistic may be calculated as:

BLER=(# of CRC pass)/(# of PUSCH transmission)<Target_BLER (about 1˜10%)

In the above equations, let
f(SINR) be a function of SINR for the link adaptation,
α: be a parameter that controls the degree of PL compensation, ranging from 0 (no compensation) to 1 (full compensation),
ΔTF: be a parameter that depends on the transport format (modulation and coding scheme) and the number of allocated RBs,
ΔMCS: be a parameter that depends on the modulation and coding scheme,
ΔF: be a parameter that depends on the frequency domain location, and
ΔTPC: be a power adjustment based on PC commands from the BS scheduler.

When coverage checker 312 determines that an improvement needed 314 is No, then no action is taken. When coverage checker 312 determines that an improvement needed 314 is Yes, then feature consolidator 310 identifies a feature combination using combination creator 318, constraint checker 320 and synergy checker 322.

Module configurator 316 determines valid feature combinations based on a channel/service requested via an uplink, relationships between features applicable to the service/channel, and operational policy 304. In some embodiments, module configurator 316 is invoked for every Yes from coverage checker 312. In some embodiments, module configurator 316 is invoked less frequently.

FIG. 4 is an exemplary functional framework for a feature compositor according to various embodiments.

A framework 400 for RAN intelligence may include data collection module 402. Data collection module 402 provides input or training data 410 to a Model Training module 404 and a Model inference module 406. Examples of training data 410 include the configuration and measurement data (not shown) from a DU. Training data 410 includes data needed as input for Model training module 404. Model training module 404 may include an AI/ML function. Data collection module 402 may provide inference data 412 as input for the Model inference module 406.

Model Training module 404 performs the AI/ML model training, validation, and testing. Model inference module 406 may generate model performance metrics or feedback 418 as part of the model testing procedure. Model deployment/update 420 may be used to initially deploy a trained, validated, and tested AI/ML model to the Model Inference module 406 or to deliver an updated model to the Model Inference module 406.

Model Inference module 406 provides an AI/ML model inference output. Model Inference module 406 may provide a Model Performance Feedback 418 to model training module 404 when applicable. Model performance feedback 418 may be for monitoring the performance of the AI/ML model, when available. Feedback 418 may be used to derive training data, inference data or to monitor the performance of the AI/ML Model and its impact to the network through updating of KPIs and performance counters. In some embodiments, model Inference module 406 may use an AI/ML model to produce an output 414. Output 414 may include optimized configuration parameters.

Actor 408 receives the output 414 from the Model Inference module 406 and triggers or performs corresponding actions, for example, via feature applicator 306 of FIG. 3.

FIG. 5 illustrates a system to provide enhanced uplink coverage enhancement in a RAN, according to various embodiments.

A 5G system 500 may include a RAN Intelligent Controller (RIC). 5G system 500 collects measurement data from DUs, detects users and services with insufficient UL coverage, and infers the optimal coverage enhancement solution by considering cell operation policies, feature relationships and synergy benefits. 5G system 500 evaluates and optimizes feature combinations. For example, a PUSCH related policy may configure only features that match the given policies among candidate features to enhance PUSCH coverage. In some embodiments, services transmitted from PUSCH, including VoNR, large data (eMBB), small data (mMTC), reliable data (URLLC), and Msg3 for initial access, may be enhanced.

The RIC may be included in a Service Management and Orchestration layer of the ORAN. The RIC may include a Non-RT RIC platform 502 and a Near-RT RIC platform 510, where RT is an acronym for real-time. 5G system 500 also includes E2 nodes 520, and ULs 522. A RIC may be a software-defined component of an Open Radio Access Network (Open-RAN) architecture, which is responsible for controlling and optimizing RAN functions. RANs that are not open may include components providing the same functionality as the RIC of an ORAN.

Non-RT RIC platform 502 may include an operation policy 504 that is transferred to the Near-RT RIC 510 via an interface, for example, the A1 I/F interface in an ORAN. Operation policy 504 may include PUSCH related policies. PUSCH related policies include the RAN architecture supported by the cell, services and features preferred by the operator, and various values and thresholds for assessing coverage gaps and determining feature combination. For example, policies related to RAN architecture include whether the RAN structure of the cell is centralized or distributed, whether it supports Multi-TRP architecture, and whether inter-cell or inter-DU information exchange is supported. Policies related to service and feature include minimum data rate, latency requirements, and link budget (MAPL) for VONR/eMBB/mMTC/URLLC services set by the operator, which coverage enhancement features are supported, and which features are to be combined with priority. Policies related to target values and thresholds include power headroom thresholds, target path loss and target Block Error Rate (BLER) for each service set by the operator.

Near-RT RIC platform 510 communicates with E2 nodes 520 to. E2 nodes 520 include CUs, DUs and RUs. The E2 nodes 520 may measure, receive, calculate or otherwise determine Key Performance Measurement (KPM) data for some or all ULs being currently serviced. KPM data is transferred to Near-RT RIC platform 510 via an interface and presented to a feature consolidator 512. For example, the E2 nodes 520 may transfer KPM data to the Near-RT RIC platform 510 in an ORAN via an E2 I/F.

The KPM data from E2 nodes 520 may be transferred in near real-time and used by feature consolidator 512 and a UL coverage checker 514. UL coverage checker 514 determines a coverage deficiency in a currently serviced UL. As such, UL coverage checker 514 identifies and selects a target UL receiving poor coverage based on UL metrics included in the KPM data. Exemplary KPM data includes UE RSRP, UE power headroom, PUSCH BLER and Signal to Interference and Noise Ratio (SINR).

Feature consolidator 512 uses KPM data of the target UL to consolidate features interconnections between features of a UE initiating the UL and features of the RAN. The feature interconnections are valid feature combinations for use with the target UL. Feature consolidator 512 may then determine which one of the valid feature combinations results in maximizing communications over the target UL.

Feature consolidator 512 may use an AI/ML model to run model inferences for the valid feature combinations to identify and select the feature combination that provides a maximal improvement to the UL coverage. For example, model inferences related to PUSCH coverage enhancement features may include Slot aggregation, Repetition type A/B, Intra/inter-slot frequency hopping, CoMP reception, TBoMS, JCE with DMRS bundling, Multi-TRP repetition, Dynamic waveform switching, and FDSS.

A feature combination sender 516 may transfer the selected feature combination to a RAN Control as parameters to E2 nodes 520 via the E2 I/F. The RAN Control changes the features of the UL per the selected feature combination. The output of feature combination sender 516 may include the selected feature combination and may also include one or more of the number of aggregated slots for slot aggregation, the number of repetitions for Repetition Type A/B, the intra/inter-slot frequency hopping patterns, the candidate cell/DU list for intra/inter-DU CoMP and multi-TRP repetition, and the number of coherently bundled DMRSs for JCE.

UEs 522 may include poor coverage UEs (not shown). Poor coverage UEs may be geolocated on or near a cell/sector edge. Poor coverage UEs may be disposed indoors.

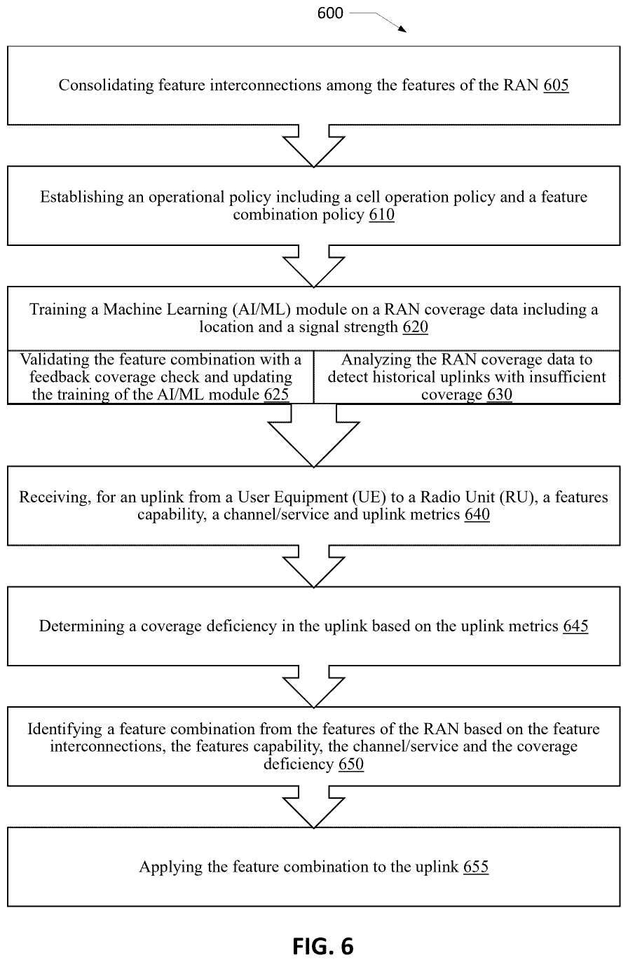

FIG. 6 illustrates a method for enhancing coverage using features of a Radio Access Network coverage according to various embodiments.

A method 600 for enhancing coverage using features of a Radio Access Network (RAN) uses supported features of a UE in conjunction with features available at a RAN RU. In method 600, measurement data from E2 nodes (CUs, DUs, RUs) is received and used to determine users and services with insufficient UL coverage (see for example, operation 640, UL coverage checker 514), and an optimal coverage enhancement solution is identified/inferred (see for example, operation 650, feature consolidator 512) by considering cell operation policies, feature relationships, and synergy benefits. Method 600 may leverage AI/ML inferences to improve decision-making for feature combinations and to train for inferring synergy benefits of all possible combinations of feature combinations. Method 600 may train a Machine Learning (AI/ML) module on RAN coverage data including a location and a signal strength.

Method 600 includes operation 605 for consolidating feature interconnections among the features of the RAN. Operation 605 consolidates feature interconnections among the features of the RAN to enhance coverage by determining optimal feature combinations. A synergy benefit is maximized when using feature combinations to enhance the UL coverage. The feature combinations after considering that any two available feature capabilities are related as either not combinable, constrained, independent, synergistic, or synergistic with constraints.

ULs subject to feature enhancement are selected from a list of specific types of channels/services, including Physical Uplink Shared Channel (PUSCH)/Voice over New Radio (VoNR), PUSCH/large data (enhanced Mobile Broadband, eMBB), PUSCH/small data (massive Machine Type Communications, mMTC), PUSCH/reliable data (Ultra-Reliable Low-Latency Communications, URLLC), PUSCH/Msg3, Physical Uplink Control Channel (PUCCH), or Physical Random Access Channel (PRACH).

Features are integral to the system's ability to enhance uplink (UL) coverage by leveraging various technologies and configurations. Exemplary features, of the RAN and the UE, include one or more of Repetition Type A, Repetition Type B, Intra/Inter-slot Frequency Hopping (FH), Intra/Inter-DU COMP Reception, TB over Multi-Slots (TBoMS), DMRS Bundling & Joint Channel Estimation (JCE), Dynamic PUCCH Repetition, Multi-TRP repetition, Dynamic Waveform Switching, Frequency Domain Spectrum Shaping (FDSS), or PRACH repetition.

Method 600 includes operation 610 for establishing an operational policy including a cell operation policy and a feature combination policy. The operational policy guides the feature consolidator in determining the optimal solutions for enhancing uplink (UL) coverage by considering various factors such as cell operation policies, feature relationships, and synergy benefits.

Method 600 includes operation 620 for training a Machine Learning (AI/ML) module on a RAN coverage data including UL metrics that is historical. The training teaches the AI/ML module to infer the most effective feature combinations based on enhancements achieved by a respective UL after application of a feature combination.

Method 600 includes operation 625 for validating the feature combination with a feedback coverage check and updating the training of the AI/ML module. In some embodiments, this continuous learning process helps in improving decision-making for feature combinations by utilizing artificial intelligence and machine learning to determine the most effective combinations of features for UL coverage enhancement.

Method 600 includes operation 630 for analyzing the RAN coverage data to detect historical uplinks with insufficient coverage and predictively applying the feature combination. In some embodiments, a gain from a feature combination may be time varying.

Method 600 includes operation 640 for receiving, for an uplink from a User Equipment (UE) to a Radio Unit (RU), a features capability, a channel/service and uplink metrics.

Method 600 includes operation 645 for determining a coverage deficiency in the uplink based on the uplink metrics.

Method 600 includes operation 650 for identifying a feature combination from the features of the RAN based on the feature interconnections, the features capability, the channel/service and the coverage deficiency. For a given set of UL metrics, identification of the inference may be performed by a trained AI/ML module.

Method 600 includes operation 655 for applying the feature combination to the uplink. Operation 655 may be performed by various E2 nodes 520 per the feature combination communicated from the feature combination sender 516 to the E2 nodes 520.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A system to enhance coverage using features of a Radio Access Network (RAN), the system comprising:
a feature consolidator configured
to consolidate feature interconnections among the features of the RAN,
to receive, for an uplink from a User Equipment (UE) to a Radio Unit (RU), a features capability, a channel/service and uplink metrics,
to determine a coverage deficiency in the uplink based on the uplink metrics, and
to identify a feature combination based on the feature interconnections, the features capability, the channel/service and the coverage deficiency; and
a feature applicator configured to apply the feature combination to a transmission of the uplink in real-time or near real time mode,
wherein any two features of the features of the RAN are related as either not combinable, constrained, independent, synergistic, or synergistic with constraints, and
wherein the identifying maximizes a synergy benefit of the feature combination.

2. The system of claim 1, further comprising an operational policy comprising a cell operation policy and a feature combination policy, wherein the feature consolidator is configured to identify by inferring the feature combination based on the operational policy.

3. The system of claim 1, wherein the channel/service is selected from a Physical Uplink Shared Channel (PUSCH)/Voice over New Radio (VONR), PUSCH/large data (enhanced Mobile Broadband, eMBB), PUSCH/small data (massive Machine Type Communications, mMTC), PUSCH/reliable data (Ultra-Reliable Low-Latency Communications, URLLC), PUSCH/Msg3, Physical Uplink Control Channel (PUCCH), or Physical Random Access Channel (PRACH).

4. The system of claim 1, wherein the features of the RAN comprise one or more of Repetition Type A, Repetition Type B, Intra/Inter-slot Frequency Hopping (FH), Intra/Inter-DU COMP Reception, TB over Multi-Slots (TBoMS), DMRS Bundling & Joint Channel Estimation (JCE), Dynamic PUCCH Repetition, Multi-TRP repetition, Dynamic Waveform Switching, Frequency Domain Spectrum Shaping (FDSS), or PRACH repetition.

5. The system of claim 1, wherein the feature consolidator is further configured to train a Machine Learning (AI/ML) module on a RAN coverage data comprising a location and a signal strength.

6. The system of claim 5, wherein the feature consolidator identifies the feature combination using an output of the (AI/ML) module.

7. The system of claim 5, wherein the feature consolidator determines the feature combination using an output of the (AI/ML) module.

8. The system of claim 5, wherein the feature consolidator is further configured to validate the feature combination with a feedback coverage check and to update the training of the AI/ML module.

9. The system of claim 5, wherein the feature consolidator is further configured to analyze the RAN coverage data to detect historical uplinks with insufficient coverage and to predictively apply the feature combination.

10. The system of claim 5, wherein the feature consolidator is further configured to analyze the RAN coverage data to detect that a gain from the feature combination is time-varying and to predictively determine the feature combination with the AI/ML module.

11. A method for enhancing coverage using features of a Radio Access Network (RAN), the method comprising:
consolidating feature interconnections among the features of the RAN;
receiving, for an uplink from a User Equipment (UE) to a Radio Unit (RU), a features capability, a channel/service and uplink metrics;
determining a coverage deficiency in the uplink based on the uplink metrics;
identifying a feature combination from the features of the RAN based on the feature interconnections, the features capability, the channel/service and the coverage deficiency; and
applying the feature combination to a transmission of the uplink,
wherein any two features of the features of the RAN are related as either not combinable, constrained, independent, synergistic, or synergistic with constraints, and
wherein the identifying maximizes a synergy benefit of the feature combination.

12. The method of claim 11, further comprising establishing an operational policy comprising a cell operation policy and a feature combination policy, wherein the identifying further comprises inferring the feature combination based on the operational policy.

13. The method of claim 11, wherein the channel/service is selected from a Physical Uplink Shared Channel (PUSCH)/Voice over New Radio (VONR), PUSCH/large data (enhanced Mobile Broadband, eMBB), PUSCH/small data (massive Machine Type Communications, mMTC), PUSCH/reliable data (Ultra-Reliable Low-Latency Communications, URLLC), PUSCH/Msg3, Physical Uplink Control Channel (PUCCH), or Physical Random Access Channel (PRACH).

14. The method of claim 11, wherein the features of the RAN comprise one or more of Repetition Type A, Repetition Type B, Intra/Inter-slot Frequency Hopping (FH), Intra/Inter-DU COMP Reception, TB over Multi-Slots (TBoMS), DMRS Bundling & Joint Channel Estimation (JCE), Dynamic PUCCH Repetition, Multi-TRP repetition, Dynamic Waveform Switching, Frequency Domain Spectrum Shaping (FDSS), or PRACH repetition.

15. The method of claim 11, wherein the consolidating of the feature interconnections further comprises training a Machine Learning (AI/ML) module on a RAN coverage data comprising a location and a signal strength.

16. The method of claim 15, wherein the identifying comprises identifying the feature combination using an output of the (AI/ML) module.

17. The method of claim 15, wherein the consolidating further comprises validating the feature combination with a feedback coverage check and updating the training of the AI/ML module.

18. The method of claim 15, wherein the consolidating comprises analyzing the RAN coverage data to detect historical uplinks with insufficient coverage and predictively applying the feature combination.

19. The method of claim 15, wherein the consolidating comprises analyzing the RAN coverage data to detect that a gain from the feature combination is time-varying and predictively determining the feature combination with the AI/ML module.

20. A non-transitory processor-readable storage medium having stored therein program code of one or more software programs for enhancing coverage using features of a Radio Access Network (RAN), wherein the program code when executed by at least one processing device causes the at least one processing device the perform:
consolidating feature interconnections among the features of the RAN;
receiving, for an uplink from a User Equipment (UE) to a Radio Unit (RU), a features capability, a channel/service and uplink metrics;
determining a coverage deficiency in the uplink based on the uplink metrics;
identifying a feature combination from the features of the RAN based on the feature interconnections, the features capability, the channel/service and the coverage deficiency; and
applying the feature combination to a transmission of the uplink,
wherein any two features of the features of the RAN are related as either not combinable, constrained, independent, synergistic, or synergistic with constraints, and
wherein the identifying maximizes a synergy benefit of the feature combination.
